(19) United States
(12) Patent Application Publication
(10) Pub. No.: US 2017/0053179 A1
(43) Pub. Date: Feb. 23, 2017

(54) METHOD AND APPARATUS FOR DETECTING THIN LINE

(71) Applicants: SAMSUNG ELECTRONICS CO., LTD., Suwon-si (KR); INHA INDUSTRY PARTNERSHIP INSTITUTE, Incheon (KR)

(72) Inventors: Hyung-jun PARK, Seongnam-si (KR); Jang-hyeon Bae, Seoul (KR); Seul-ki Jang, Suwon-si (KR); Choon-woo Kim, Seoul (KR); Ji-young Yi, Suwon-si (KR); Hyun-seung Lee, Seoul (KR); Jae-uk Kim, Incheon (KR); Chang-gon Kim, Incheon (KR); Kwang-sik Shin, Incheon (KR); Hye-sung Jang, Ulsan (KR)

(73) Assignees: SAMSUNG ELECTRONICS CO., LTD., Suwon-si (KR); INHA INDUSTRY PARTNERSHIP INSTITUTE, Incheon (KR)

(21) Appl. No.: 15/076,940

(22) Filed: Mar. 22, 2016

(30) Foreign Application Priority Data
Aug. 17, 2015 (KR) 10-2015-0115416

(51) Int. Cl. G06K 9/20; G06K 9/62; G06T 7/00

(52) U.S. Cl. CPC G06K 9/2054; G06T 7/0085; G06K 9/6202; G06T 2207/10008; G06T 2207/30176

(57) ABSTRACT

A method of detecting a thin line by an image forming apparatus includes selecting a candidate region of the thin line from image data; splitting the candidate region into a plurality of detail regions; determining a shape of the thin line by comparing pixel values of the plurality of detail regions; and detecting the thin line having the determined shape from the image data.

### CROSS-REFERENCE TO RELATED APPLICATIONS

This application claims the priority benefit of Korean Patent Application No. 10-2015-0115416, filed on Aug. 17, 2015, in the Korean Intellectual Property Office, the disclosure of which is incorporated herein in its entirety by reference.

### BACKGROUND

1. Field

The following description relates to methods and apparatuses for detecting a thin line, and more particularly, to a method of detecting, by an image forming apparatus, a thin line while forming an image, and the image forming apparatus.

2. Description of the Related Art

A printer uses a halftone pattern to express brightness while printing an image. In other words, the printer expresses the image by printing a plurality of dots on a sheet of paper, and brightness and an intermediate concentration of the image are expressed via half-toning by adjusting the number of dots to determine a density of the dots in a predetermined region, and a pattern formed as such is referred to as the halftone pattern.

When a document including a halftone pattern is printed by a printer and then copied, if the document is scanned to obtain image data and the obtained image data is half-toned according to resolution of a photocopier, a final output document may exhibit a Moiré phenomenon due to half-toning frequency interference between the printer and the photocopier. Accordingly, in order to prevent such a Moiré phenomenon, before half-toning a scan image according to a resolution of the photocopier, an operation of removing a halftone pattern included in the scan image, i.e., a descreening operation, is performed. Meanwhile, a thin line having a predetermined thickness or less may be mistaken as a halftone pattern. In this case, the thin line may be removed together with the halftone pattern during the descreening operation.

### SUMMARY

Additional aspects and/or advantages will be set forth in part in the description which follows and, in part, will be apparent from the description, or may be learned by practice of the disclosure.

According to an aspect of an embodiment, a method of detecting, by an image forming apparatus, a thin line, the method includes: selecting a candidate region of the thin line from image data; splitting the candidate region into a plurality of detail regions; determining a shape of the thin line by comparing pixel values of the plurality of detail regions; and detecting the thin line having the determined shape from the image data.

The determining of the shape may include classifying the plurality of detail regions into background candidate regions and thin line candidate regions to correspond to a thin line candidate shape comprising background regions and thin line regions.

The determining of the shape may include: determining whether the thin line included in the candidate region matches the thin line candidate shape by comparing pixel values of pixels corresponding to the background candidate regions and pixel values of pixels corresponding to the thin line candidate regions; and when the thin line matches the thin line candidate shape, determining the thin line candidate shape as the shape of the thin line.

The determining of whether the thin line matches the thin line candidate shape may include determining whether the thin line matches the thin line candidate shape by selecting minimum pixel values of the plurality of detail regions and determining whether minimum pixel values of detail regions classified as thin line candidate regions are smaller than minimum pixel values of detail regions classified as the background candidate regions, and the determining of the shape of the thin line may include, when the thin line matches the thin line candidate shape, determining the thin line as a positive thin line having the thin line candidate shape.

The determining of whether the thin line matches the thin line candidate shape may include determining whether the thin line matches the thin line candidate shape by selecting maximum pixel values of the plurality of detail regions and determining whether maximum pixel values of detail regions classified as the thin line candidate regions are larger than maximum pixel values of detail regions classified as the background candidate regions, and the determining of the shape of the thin line may include, when the thin line matches the thin line candidate shape, determining the thin line as a negative thin line having the thin line candidate shape.

The determining of the shape of the thin line may further include checking the shape of the thin line by determining whether pixel values of pixels corresponding to the shape of the thin line are within a threshold range.

The detecting of the thin line may include detecting the thin line when a shape of a thin line included in a low resolution image of the image data matches the shape of the thin line.

The low resolution image may be an image generated by using an average pixel value of pixels of the image data.

The detecting of the thin line may include adjusting pixels corresponding to the thin line to have a same pixel value.

The candidate region may include a pixel having a pixel value that is different from pixel values of adjacent pixels by at least a threshold value, from among the pixels included in the image data.

According to an aspect of an embodiment, an image forming apparatus includes: a controller configured to select a candidate region of a thin line from image data, split the candidate region into a plurality of detail regions, determine a shape of the thin line by comparing pixel values of the plurality of detail regions, and detect the thin line having the determined shape from the image data; and an output unit configured to output the image data comprising the detected thin line.

The controller may classify the plurality of detail regions into background candidate regions and thin line candidate regions to correspond to a thin line candidate shape including background regions and thin line regions.

The controller may determine whether the thin line included in the candidate region matches the thin line candidate shape by comparing pixel values of pixels corresponding to the background candidate regions and pixel values of pixels corresponding to the thin line candidate regions, and when the thin line matches the thin line candidate shape, determine the thin line candidate shape as the shape of the thin line.

The controller may select minimum pixel values of the plurality of detail regions, determine that the thin line matches the thin line candidate shape when minimum pixel values of detail regions classified as thin line candidate regions are smaller than minimum pixel values of detail regions classified as the background candidate regions, and determine the thin line as a positive thin line having the thin line candidate shape.

The controller may select maximum pixel values of the plurality of detail regions, determine that the thin line matches the thin line candidate shape when maximum pixel values of detail regions classified as the thin line candidate regions are larger than maximum pixel values of detail regions classified as the background candidate regions, and determine the thin line as a negative thin line having the thin line candidate shape.

The controller may check the shape of the thin line by determining whether pixel values of pixels corresponding to the shape of the thin line are within a threshold range.

The controller may detect the thin line when a shape of a thin line included in a low resolution image of the image data matches the shape of the thin line.

The low resolution image may be an image generated by using an average pixel value of pixels of the image data.

The controller may adjust pixels corresponding to the thin line to have a same pixel value.

According to an aspect of an embodiment, a non-transitory computer-readable recording medium has recorded thereon a program, which when executed by a computer, performs the method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a flowchart of a method of detecting a thin line, according to an embodiment;

FIG. 2 is a diagram for describing a method of selecting, by an image forming apparatus, a candidate region, according to an embodiment;

FIG. 3 illustrates an example of splitting, by an image forming apparatus, a candidate region into detail regions;

FIG. 4 is a flowchart of a method of determining, by an image forming apparatus, a thin line candidate shape by comparing pixel values of detail regions, according to an embodiment;

FIGS. 5A and 5B illustrate examples of thin line candidate shapes;

FIGS. 6 and 7 illustrate examples of determining, by an image forming apparatus, whether a shape of a thin line included in a candidate region matches one of the thin line candidate shapes of FIGS. 5A and 5B;

FIG. 8 is a flowchart of a method of determining, by an image forming apparatus, a shape of a thin line by comparing pixel values of detail regions, according to an embodiment;

FIG. 9 illustrates an example of determining, by an image forming apparatus, a shape of a thin line included in a candidate region;

FIG. 10 is a flowchart of a method of determining, by an image forming apparatus, whether a thin line included in a candidate region is continuous, according to an embodiment;

FIG. 11 illustrates an example of determining, by an image forming apparatus, whether a thin line included in a candidate region is continuous;

FIG. 12 is a flowchart of a method of verifying, by an image forming apparatus, a shape of a thin line, according to an embodiment;

FIG. 13 illustrates an example of verifying, by an image forming apparatus, a shape of a thin line by using a low resolution image;

FIG. 14 is a flowchart of a method of adjusting and outputting, by an image forming apparatus, pixel values of a detected thin line, according to an embodiment;

FIG. 15 illustrates an example of image data output by an image forming apparatus;

FIG. 16 is a block diagram of an image forming apparatus according to an embodiment;

FIG. 17 is a block diagram of a controller of FIG. 16; and

FIG. 18 is a block diagram illustrating in detail an image forming apparatus.

### DETAILED DESCRIPTION

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

It will be understood that although the terms first and second are used herein to describe various elements, these elements should not be limited by these terms. These terms are only used to distinguish one element from another element. Thus, a first element discussed below could be termed a second element, and similarly, a second element may be termed a first element without departing from the teachings of this disclosure. As used herein, the term “and/or” includes any and all combinations of one or more of the associated listed items. Expressions such as “at least one of,” when preceding a list of elements, modify the entire list of elements and do not modify the individual elements of the list.

When a part “includes” or “comprises” an element, unless there is a particular description contrary thereto, the part may further include other elements, not excluding the other elements. Also, the term “unit” in the embodiments of the present invention means a software component or hardware component such as a field-programmable gate array (FPGA) or an application-specific integrated circuit (ASIC), and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with the smaller number of components and “units”, or may be divided into additional components and “units”.

Reference will now be made in detail to embodiments, examples of which are illustrated in the accompanying drawings. In this regard, the present embodiments may have different forms and should not be construed as being limited to the descriptions set forth herein. In the following description, well-known functions or constructions are not described in detail so as not to obscure the embodiments with unnecessary detail. Also, like reference numerals refer to like elements.

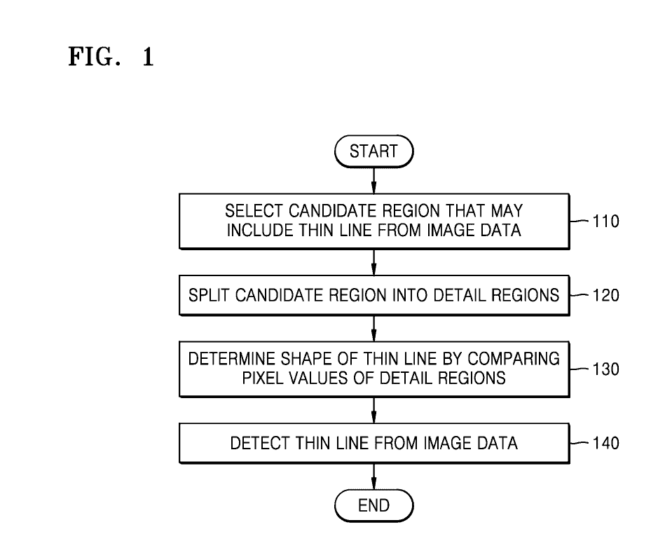

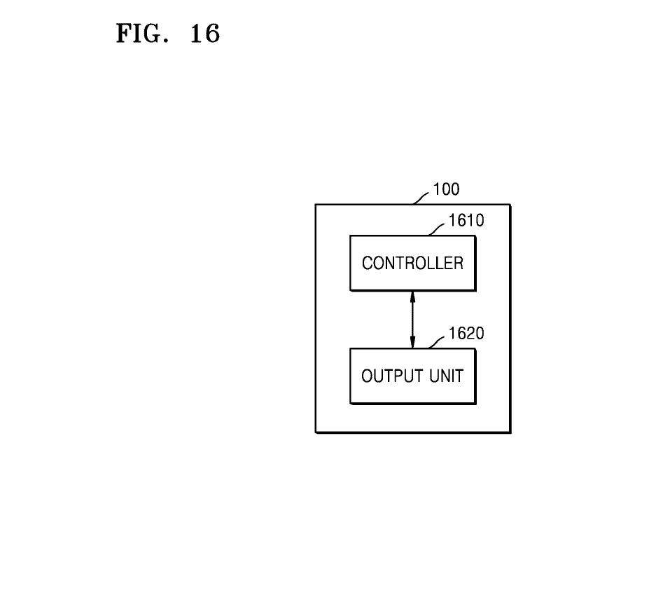

FIG. 1 is a flowchart of a method of detecting a thin line, according to an embodiment. The method of FIG. 1 may be performed by an image forming apparatus 100 of FIG. 16. Meanwhile, the image forming apparatus 100 may be a multi-function printer (MFP) in which functions of a printer, a scanner, a photocopier, and a facsimile are combined. Hereinafter, for convenience of description, it is assumed that the image forming apparatus 100 performs the method of FIG. 1.

Referring to FIG. 1, in operation 110, the image forming apparatus 100 selects a candidate region that may include a thin line, from image data. Here, the image data is data including a plurality of pixels, and for example, may be generated as an original document is scanned by the image forming apparatus 100 or may be received from an external source. Also, the thin line may be a group of pixels having the same or similar pixel values and may have a thickness of one or two pixels. The thin line may be classified into a positive thin line having saturation lower than adjacent pixels and a negative thin line having saturation higher than adjacent pixels.

Also, the candidate region may be an N×N pixel region in which the thin line is expected to be included in the image data, for example, may be a 7×7 pixel region.

According to an embodiment, the image forming apparatus 100 may select the candidate region by comparing pixel values of the pixels included in the image data with a first threshold value. Here, when the image forming apparatus 100 uses an RGB color space, the pixel value may be expressed in an 8-bit value between 0x00 to 0xFF according to red, green, and blue channels (i.e., RGB channels), or may be expressed in a 24-bit value by combining the 8-bit values (i.e., 0x000000 to 0xFFFFFF) or in a 32-bit value by further combining an opacity value to the 24-bit value.

The image forming apparatus 100 may compare RGB pixel values of a pixel with the first threshold value (for example, 0xB4). In detail, when the RGB pixel values are smaller than (or larger than) the first threshold value, the image forming apparatus 100 may select the pixel as a candidate pixel that may be included in the thin line. Then, the image forming apparatus 100 may compare RGB pixel values of adjacent pixels of the candidate pixel with the first threshold value (for example, 0xB4). Here, the adjacent pixel may be a pixel located at least two pixels away from the candidate pixel. The image forming apparatus 100 compares the RGB pixel values of the adjacent pixels with the first threshold value to determine whether the adjacent pixels include a thin line having a thickness of one or two pixels. Accordingly, the image forming apparatus 100 may select a candidate region around the candidate pixel when at least one of the RGB pixel values of the adjacent pixels is larger than (or smaller than) the first threshold value.

Alternatively, the image forming apparatus 100 may compare differences between the RGB pixel values of the candidate pixel and the RGB pixel values of the adjacent pixels with a second threshold value (for example, 0x20). When the differences are all larger than the second threshold value, the image forming apparatus 100 may select a candidate region around the candidate pixel.

Also, when the candidate region is selected, the image forming apparatus 100 may predict that the candidate region includes a positive thin line or a negative thin line based on whether a pixel value of a center pixel at the center of the candidate region are smaller or larger than pixel values of adjacent pixels.

Meanwhile, according to an embodiment, the image forming apparatus 100 may use a cyan, magenta, yellow, and black (CMYK) color space instead of the RGB color space. In this case, the image forming apparatus 100 may compare CMYK pixel values of a pixel with a threshold value. Alternatively, the image forming apparatus 100 may use a HIS color space, a YIQ color space, a YUV color space, or a YCbCr color space. In this case, the image forming apparatus 100 may compare pixel values defined by each color space with a threshold value.

In operation 120, the image forming apparatus 100 may split the candidate region into detail regions. The image forming apparatus 100 may split the candidate region into the detail regions having a pre-set shape. For example, the image forming apparatus 100 may split the candidate region into at least two detail regions including a plurality of pixels. However, the image forming apparatus 100 is not required to split all candidate regions into the detail regions, and may split some of candidate regions into the detail regions.

In operation 130, the image forming apparatus 100 determines a shape of a thin line by comparing pixel values of the detail regions.

According to an embodiment, the image forming apparatus 100 compares the pixel values of the detail regions to determine whether a thin line included in the candidate region matches one of thin line candidate shapes that are pre-set. Here, the thin line candidate shape may include background regions and thin line regions. Also, the thin line candidate shapes may include different background regions and thin line regions according to a gradient of the thin line (for example, 0°, 22.5°, 45°, 67.5°, 90°, 112.5°, 135°, or 157.5°).

In detail, the image forming apparatus 100 may classify the detail regions into the background candidate regions and thin line candidate regions to correspond to background regions and thin line regions included in a first thin line candidate shape from among the thin line candidate shapes. Here, the classifying of the detail regions to correspond to the thin line candidate shape may mean that the detail region at the same location in the candidate region as the background region in the thin line candidate shape is classified to the background candidate region.

The image forming apparatus 100 may determine whether a thin line included in the candidate region matches the first thin line candidate shape by comparing pixel values of pixels corresponding to the background candidate region and pixel values of pixels corresponding to the thin line candidate region. Here, the image forming apparatus 100 may compare minimum or maximum pixel values corresponding to the background candidate regions and minimum or maximum pixel values corresponding to the thin line candidate regions based on whether the thin line included in the candidate region is a positive thin line or a negative thin line.

Also, when the thin line included in the candidate region matches the first thin line candidate shape, the image forming apparatus 100 determines a shape of the thin line as the first thin line candidate shape.

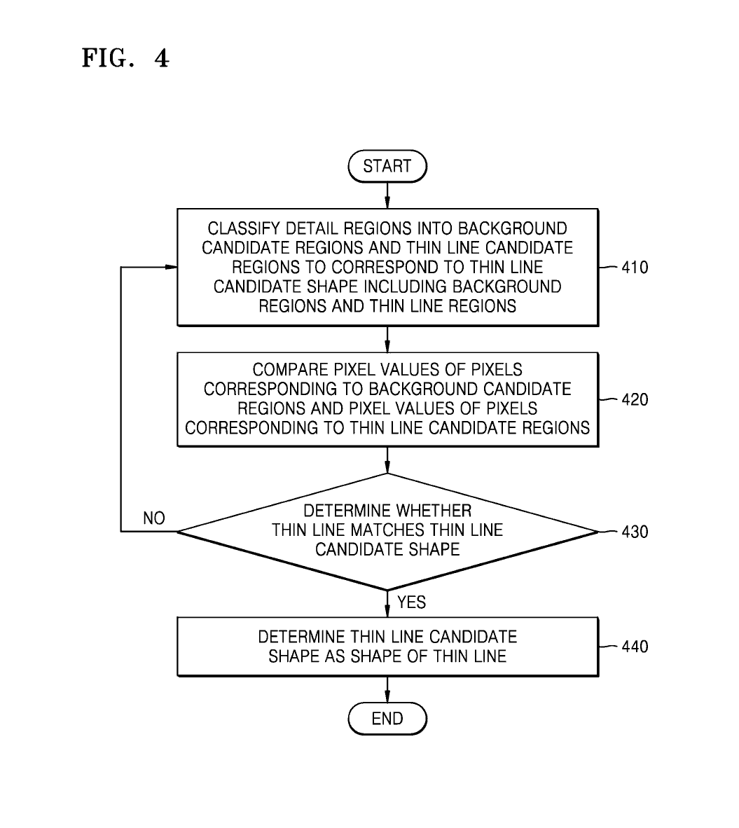

However, when the thin line included in the candidate region does not match the first thin line candidate shape, the image forming apparatus 100 may again classify the detail regions to correspond to background regions and thin line regions included in a second thin line candidate shape. As such, the image forming apparatus 100 may repeatedly perform above operations until a thin line candidate shape matching the thin line is found. A method of determining, by the image forming apparatus, a shape of a thin line by using thin line candidate shapes will be described later with reference to FIGS. 4 through 7.

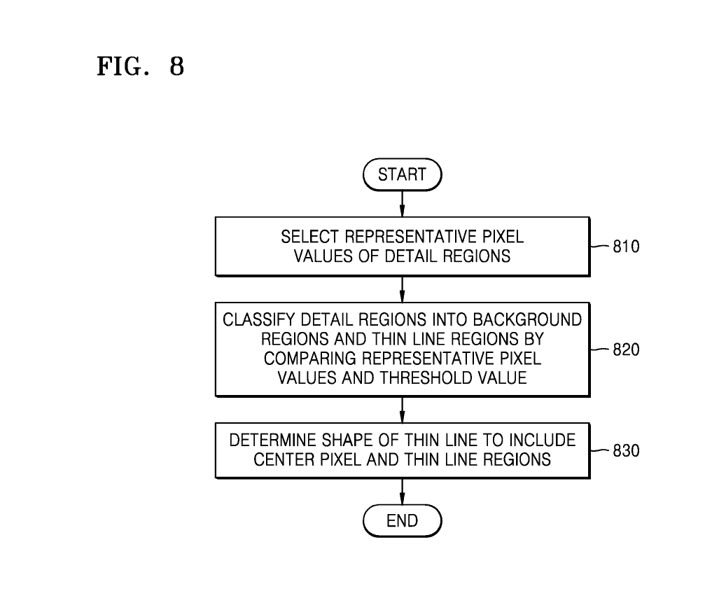

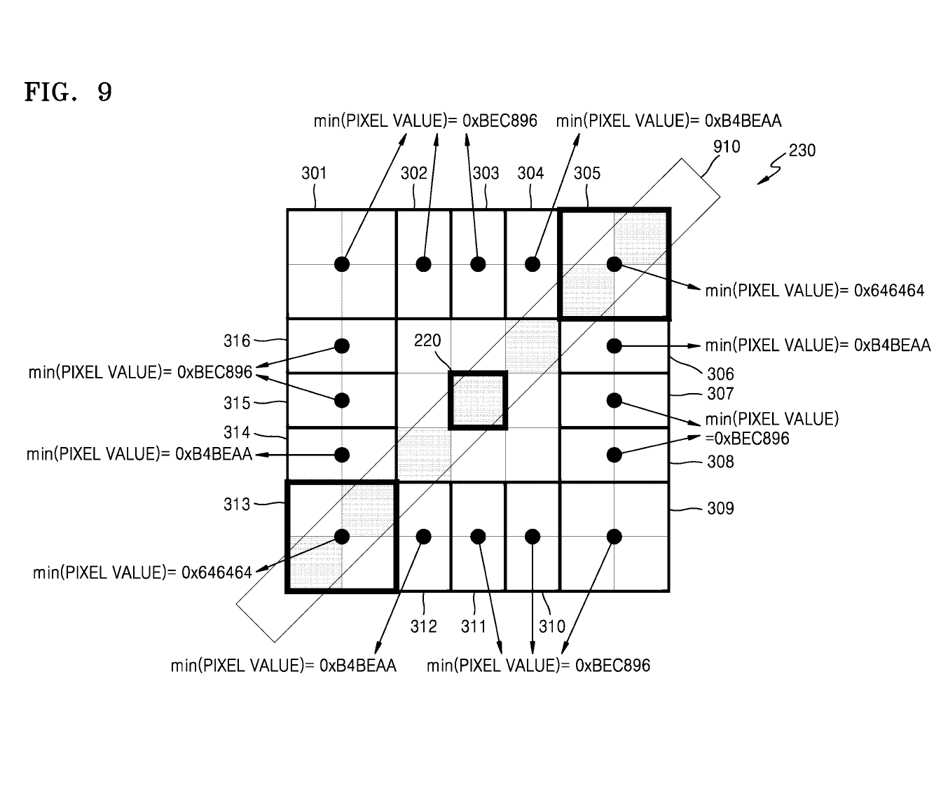

According to an embodiment, the image forming apparatus 100 may compare a representative pixel value (a maximum or minimum pixel value) of the detail region and a third threshold value to classify the detail regions into background regions and thin line regions. Here, the third threshold value may be the same as or similar to the first threshold value (for example, the third threshold value=the first threshold value−0x10 to the first threshold value+0x10). The image forming apparatus 100 may connect a pixel at the center of the candidate region and the thin line regions to determine the shape of the thin line. A method of determining, by the image forming apparatus 100, the shape of the thin line by using the representative pixel values of the detail regions will be described later with reference to FIGS. 8 and 9.

In operation 140, the image forming apparatus 100 may detect the thin line from the image data. In detail, the image forming apparatus 100 may adjust pixels corresponding to the thin line to have the same pixel values. For example, the image forming apparatus 100 may extract maximum or minimum pixel values of the pixels corresponding to the thin line and adjust the pixel values of the pixels corresponding to the thin line to the extracted maximum or minimum pixel value. Also, the image forming apparatus 100 may adjust the pixel values of the pixels corresponding to the thin line such that the thin line is clearly output or printed.

Also, the image forming apparatus 100 may skip a descreening operation performed on the pixels corresponding to the thin line. Here, the descreening operation may be performed to remove a halftone pattern included in the image data in order to prevent a Moiré phenomenon. Generally, a thin line may be mistaken as a halftone pattern and deleted during a descreening operation. Thus, the descreening operation on the pixels corresponding to the thin line may not be performed such that the thin line is prevented from being deleted from the image data by being mistaken as a halftone pattern.

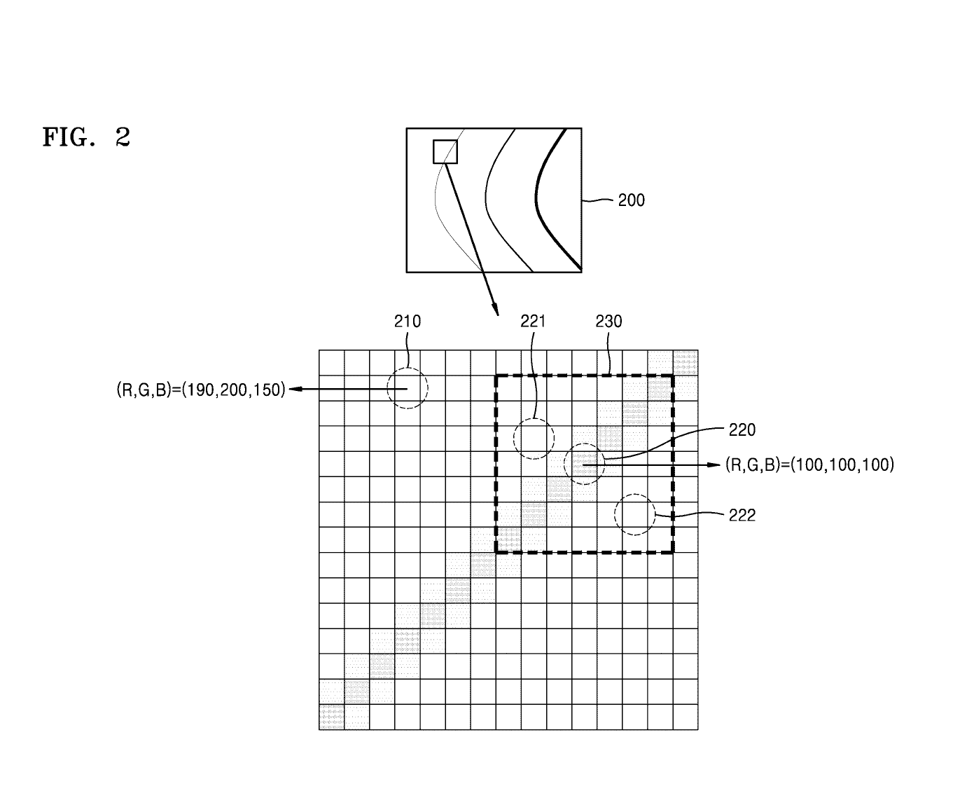

FIG. 2 is a diagram for describing a method of selecting, by the image forming apparatus 100, a candidate region, according to an embodiment.

Referring to FIG. 2, the image forming apparatus 100 may compare pixel values of pixels of image data 200 and the first threshold value (for example, 0xB4). For example, because a first pixel 210 has (0xBE, 0xC8, 0x96) as RGB pixel values, the first pixel 210 is not selected as a candidate pixel. Accordingly, the image forming apparatus 100 may compare RGB pixel values of another pixel and the first threshold value.

Meanwhile, because a second pixel 220 has (0x64, 0x64, 0x64) as RGB pixel values, the image forming apparatus 100 may compare RGB pixel values of adjacent pixels 221 and 222 of the second pixel 220 and the first threshold value. If at least one of the RGB pixel values of the adjacent pixels 221 and 222 is larger than the first threshold value, the image forming apparatus 100 may select a 7×7 pixel region around the second pixel 220 as a candidate region 230. Hereinafter, a pixel at the center of the candidate region 230 is referred to as a center pixel.

Meanwhile, because a pixel value of the second pixel 220 is smaller than pixel values of the adjacent pixels 221 and 222, the image forming apparatus 100 may predict that the candidate region 230 may include a positive thin line.

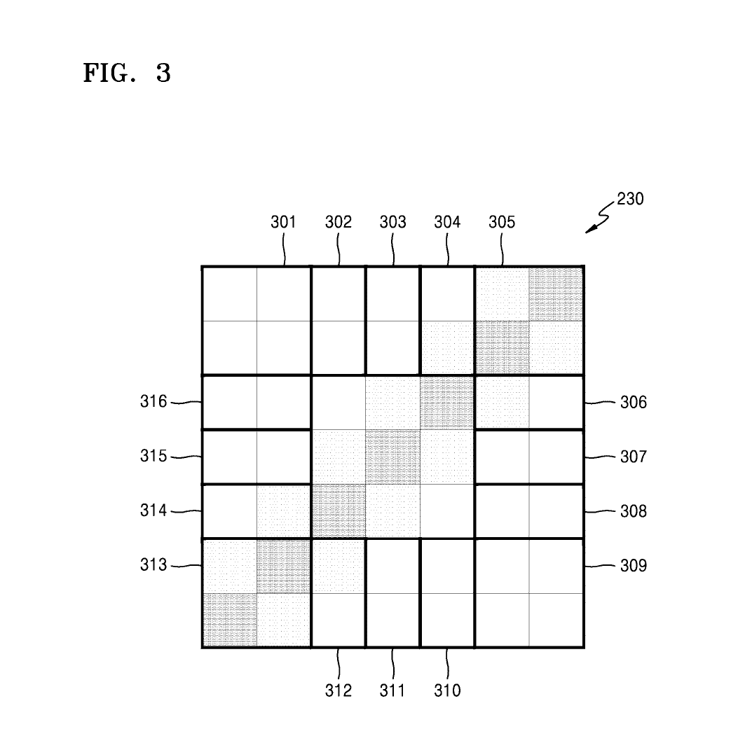

FIG. 3 illustrates an example of splitting, by the image forming apparatus 100, a candidate region into detail regions. Referring to FIG. 3, the image forming apparatus 100 may split the candidate region 230 into sixteen detail regions, i.e., first through sixteenth detail regions 301 through 316.

FIG. 4 is a flowchart of a method of determining, by the image forming apparatus 100, a thin line candidate shape by comparing pixel values of detail regions, according to an embodiment.

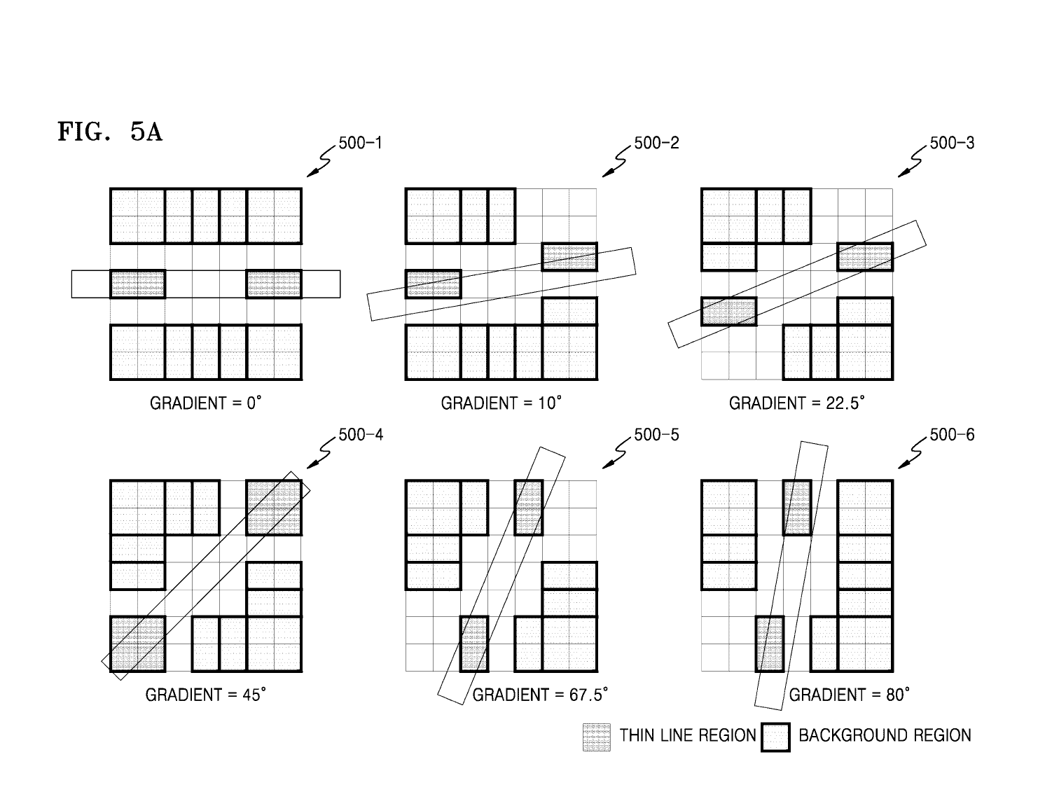

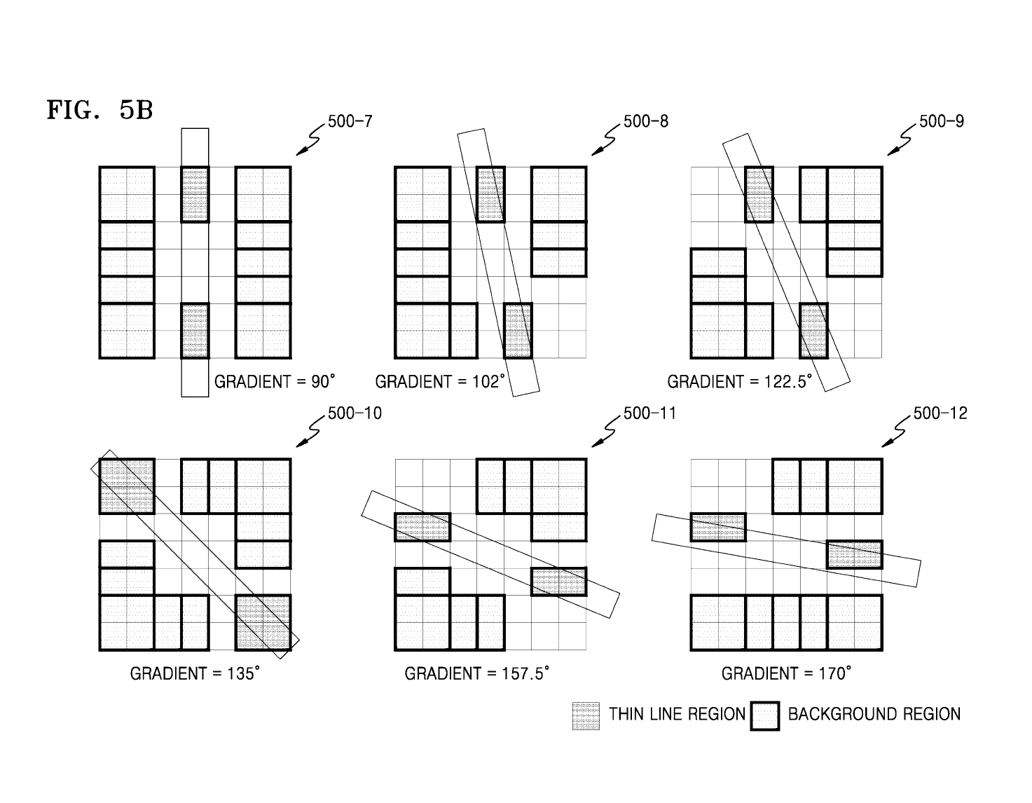

Referring to FIG. 4, in operation 410, the image forming apparatus 100 classifies the detail regions into background candidate regions and thin line candidate regions to correspond to a thin line candidate shape including background regions and thin line regions. Here, the thin line candidate shape may include the background regions and the thin line regions, which are pre-set, and for example, the image forming apparatus 100 may store various thin line candidate shapes, i.e., first through twelfth thin line candidate shapes 500-1 through 500-12, as shown in FIGS. 5A and 5B.

In detail, the image forming apparatus 100 may classify the first through sixteenth detail regions 301 through 316 of FIG. 3 to correspond to background regions and thin line regions included in one of the first through twelfth thin line candidate shapes 500-1 through 500-12.

In operation 420, the image forming apparatus 100 compares pixel values of pixels corresponding to the background candidate regions and pixel values of pixels corresponding to thin line candidate regions. Here, the image forming apparatus 100 may compare the pixel values differently based on whether a thin line included in a candidate region is predicted to be a positive thin line or a negative thin line. Because a method of predicting whether a thin line included in a candidate region is a positive thin line or a negative thin line is described above with reference to operation 110 of FIG. 1, details thereof are not provided again.

In detail, when the thin line is predicted to be a positive thin line, the image forming apparatus 100 may select minimum pixel values of the detail regions. On the other hand, when the thin line is predicted to be a negative thin line, the image forming apparatus 100 may select maximum pixel values of the detail regions.

When the minimum or maximum pixel values of the detail regions are selected, the image forming apparatus 100 may compare minimum or maximum pixel values of detail regions classified as the background candidate regions and minimum or maximum pixel values of detail regions classified as the thin line candidate regions.

For example, when the thin line included in the candidate region is predicted to be a positive thin line, the image forming apparatus 100 may determine whether the minimum pixel values of the detail regions classified as the thin line candidate regions are smaller than the minimum pixel values of the detail regions classified as the background candidate regions. Alternatively, when the thin line included in the candidate region is predicted to be a negative thin line, the image forming apparatus 100 may compare whether the maximum pixel values of the detail regions classified as the thin line candidate regions are larger than the maximum pixel values of the detail regions classified as the background candidate regions.

If the thin line included in the candidate region is predicted to be a positive thin line and the minimum pixel values corresponding to the thin line candidate regions are smaller than the minimum pixel values corresponding to the background candidate regions, the image forming apparatus 100 determines that the thin line matches the thin line candidate shape in operation 430, and performs operation 440. However, if the minimum pixel values of the detail regions classified as the thin line candidate regions are larger than the minimum pixel values corresponding to the background candidate regions, the image forming apparatus 100 determines that the thin line does match the thin line candidate shape in operation 430, and performs operation 410. Accordingly, the image forming apparatus 100 classifies the detail regions into the background candidate regions and the thin line candidate regions according to another thin line candidate shape.

Alternatively, if the thin line included in the candidate region is predicted to be a negative thin line and the maximum pixel values corresponding to the thin line candidate regions are larger than the maximum pixel values corresponding to the background candidate regions, the image forming apparatus 100 determines that the thin line matches the thin line candidate shape in operation 430, and performs operation 440, and if not, performs operation 410.

As such, the image forming apparatus 100 may repeatedly perform operations 410 through 430 until the thin line matches the thin line candidate shape.

In operation 440, the image forming apparatus 100 may determine the thin line candidate shape as a shape of the thin line. Here, the image forming apparatus 100 may also determine whether the thin line is a positive or negative thin line having the thin line candidate shape.

Meanwhile, in the above description, it is described that the image forming apparatus 100 selects the minimum or maximum pixel values of the detail regions, but the disclosure is not limited thereto. According to an embodiment, the image forming apparatus 100 may select average pixel values of the detail regions, and compare average pixel values of detail regions classified as the background candidate regions and average pixel values of detail regions classified as the thin line candidate regions.

FIGS. 5A and 5B illustrate examples of the first through twelfth thin line candidate shapes 500-1 through 500-12. As shown in FIGS. 5A and 5B, the first through twelfth thin line candidate shapes 500-1 through 500-12 may include different background regions and different thin line regions according to gradients of a thin line. For example, the first through twelfth thin line candidate shapes 500-1 through 500-12 may include different background regions and different thin line regions according to gradients of a thin line, for example, 0°, 12°, 22.5°, 45°, 67.5°, 80°, 90°, 102°, 112.5°, 135°, and 157.5°.

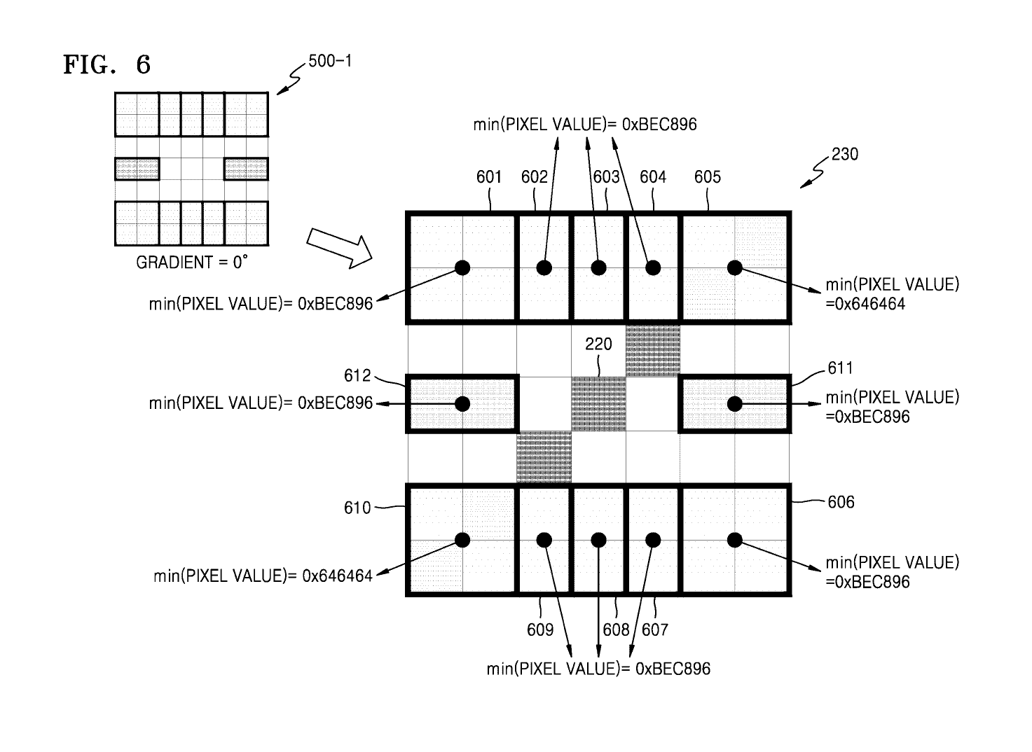

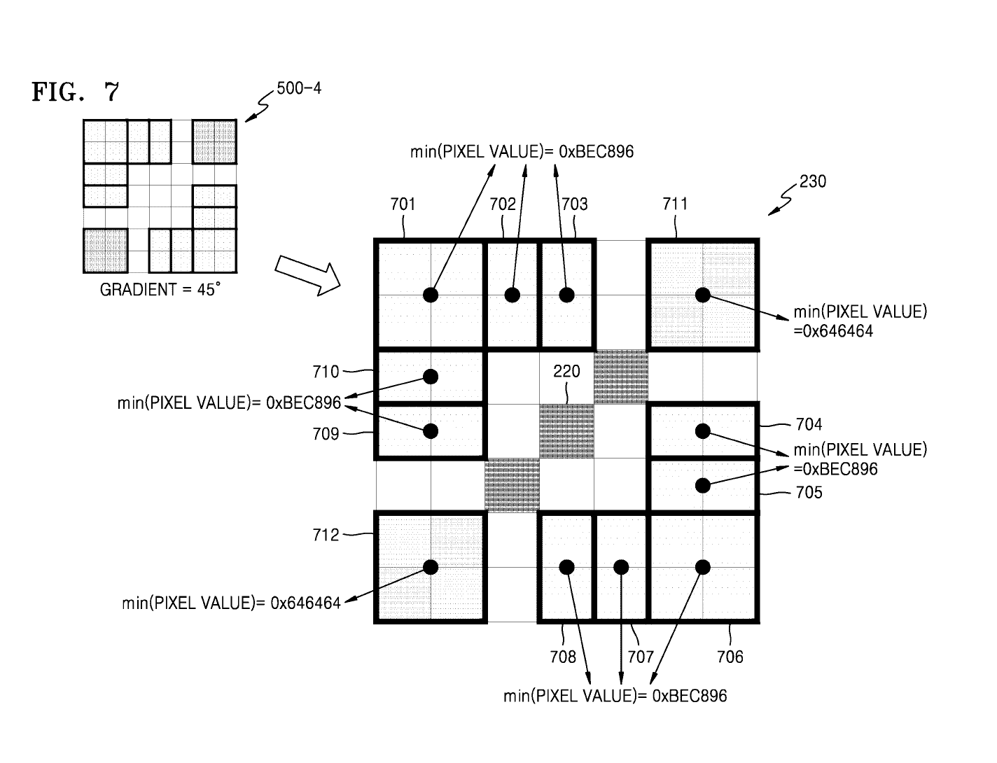

FIGS. 6 and 7 illustrate examples of determining, by the image forming apparatus 100, whether a shape of a thin line included in a candidate region matches one of the first through twelfth thin line candidate shapes 500-1 through 500-12 of FIGS. 5A and 5B.

Referring to FIG. 6, the image forming apparatus 100 may classify the first through sixteenth detail regions 301 through 316 of FIG. 3 into background candidate regions and thin line candidate regions to correspond to the thin line regions and background regions included in the first thin line candidate shape 500-1. In detail, the first through fifth detail regions 301 through 305 and the ninth through thirteenth detail regions 309 through 313 of FIG. 3 correspond to first through tenth background candidate regions 601 through 610 of FIG. 6, and the seventh and fifteenth detail regions 307 and 315 of FIG. 3 correspond to first and second thin line candidate regions 611 and 612 of FIG. 6.

The image forming apparatus 100 may compare minimum pixel values corresponding to the first through tenth background candidate regions 601 through 610 and minimum pixel values corresponding to the first and second thin line candidate regions 611 and 612. For example, the image forming apparatus 100 may compare pixel values of the first through tenth background candidate regions 601 through 610 and pixel values of the first and second thin line candidate regions 611 and 612.

In FIG. 6, because the minimum pixel value (i.e., 0xBEC896) of the first or second thin line candidate region 611 or 612 is larger than the minimum pixel values (i.e., 0x646464) of the fifth and tenth background candidate regions 605 and 610, a thin line included in the candidate region 230 does not match the first thin line candidate shape 500-1. Accordingly, the image forming apparatus 100 determines again whether the thin line included in the candidate region 230 matches another thin line candidate shape.

Referring to FIG. 7, the image forming apparatus 100 may classify the first through sixteenth detail regions 301 through 316 of FIG. 3 into the background candidate regions and the thin line candidate regions to correspond to thin line regions and background regions included in the fourth thin line candidate shape 500-4. In detail, the first through third detail regions 301 through 303, the seventh through eleventh detail regions 307 through 311, and the fifteenth and sixteenth detail regions 315 and 316 of FIG. 3 correspond to first through tenth background candidate regions 701 through 710 of FIG. 7, and the fifth and thirteenth detail regions 307 and 315 of FIG. 3 correspond to first and second thin line candidate regions 711 and 712.

In FIG. 7, unlike FIG. 6, because minimum pixel values (i.e., 0x646464) of the first and second thin line candidate regions 711 and 612 are smaller than minimum pixel values (i.e., 0xBEC896) of the first through tenth background candidate regions 701 through 710, the image forming apparatus 100 may determine that the thin line included in the candidate region 230 matches the fourth thin line candidate shape 500-4. Accordingly, the image forming apparatus 100 may stop a matching operation.

FIG. 8 is a flowchart of a method of determining, by the image forming apparatus 100, a shape of a thin line by comparing pixel values of detail regions, according to an embodiment.

Referring to FIG. 8, in operation 810, the image forming apparatus 100 selects representative pixel values of detail regions. Here, the representative pixel value may be a minimum pixel value, a maximum pixel value, or an average pixel value of the detail region. In detail, when a thin line included in a candidate region is predicted to be a positive thin line, the image forming apparatus 100 may use the minimum pixel value of the detail region as the representative pixel value. Alternatively, when the thin line included in the candidate region is predicted to be a negative thin line, the image forming apparatus 100 may use the maximum pixel value of the detail region as the representative pixel value.

In operation 820, the image forming apparatus 100 compares the representative pixel value and the third threshold value to classify the detail regions into background regions and thin line regions. Here, the third threshold value may be the same or similar value as the first threshold value used to determine a center pixel. For example, the third threshold value may be a pixel value (for example, 0xB4B4B4) when each of RGB pixel values has the first threshold value (for example, 0xB4). Accordingly, the image forming apparatus 100 compares the representative pixel values and the third threshold value to determine whether each detail region includes a thin line.

In detail, when the thin line included in the candidate region is predicted to be a positive thin line, the image forming apparatus may classify the detail region having the representative pixel value smaller than the third threshold value as the thin line region and classify the detail region having the representative pixel value larger than the third threshold value as the background region. Alternatively, when the thin line included in the candidate region is predicted to be a negative thin line, the image forming apparatus 100 may classify the detail region having the representative pixel value larger than the third threshold value as the thin line region and classify the detail region having the representative pixel value smaller than the third threshold value as the background region.

In operation 830, the image forming apparatus 100 determines a shape of the thin line to include a center pixel and the thin line regions. For example, the image forming apparatus 100 may determine a shape obtained by connecting the center pixel and the thin line regions in a straight line as the shape of the thin line. As such, the image forming apparatus 100 may detect the thin line having any shape.

Meanwhile, according to an embodiment, when a thin line included in a candidate region does not match any of thin line candidate shapes that are pre-set, the image forming apparatus 100 may determine a shape of the thin line according to the method of FIG. 8.

FIG. 9 illustrates an example of determining, by the image forming apparatus 100, a shape of a thin line included in a candidate region.

Referring to FIG. 9, the image forming apparatus 100 may compare the minimum pixel values of the first through sixteenth detail regions 301 through 316 of FIG. 3 and the third threshold value (for example, 0xB4B4B4). For example, because the minimum pixel values (i.e., 0xBEC896) of the first through third detail regions 301 through 303, the seventh through eleventh detail regions 307 through 311, the fifteenth detail region 315, and the sixteenth detail region 316 are all larger than the third threshold value, the first through third detail regions 301 through 303, the seventh through eleventh detail regions 307 through 311, the fifteenth detail region 315, and the sixteenth detail region 316 may be classified as background regions. Also, because the minimum pixel values (i.e., 0xB4BEAA) of the fourth detail region 304, the sixth detail region 306, the twelfth detail region 312, and the fourteenth detail region 314 are also all larger than the third threshold value, the fourth detail region 304, the sixth detail region 306, the twelfth detail region 312, and the fourteenth detail region 314 may also be classified as background regions. However, because the minimum pixel values (i.e., 0xA6B9A0) of the fifth detail region 305 and the thirteenth detail region 313 are all smaller than the third threshold value, the fifth detail region 305 and the thirteenth detail region 313 may be classified as thin line regions.

Then, the image forming apparatus 100 may determine a shape 910 obtained by connecting the second pixel 220, i.e., the center pixel, and the fifth and thirteenth detail regions 305 and 313, i.e., the thin line regions, in a straight line as the shape of the thin line.

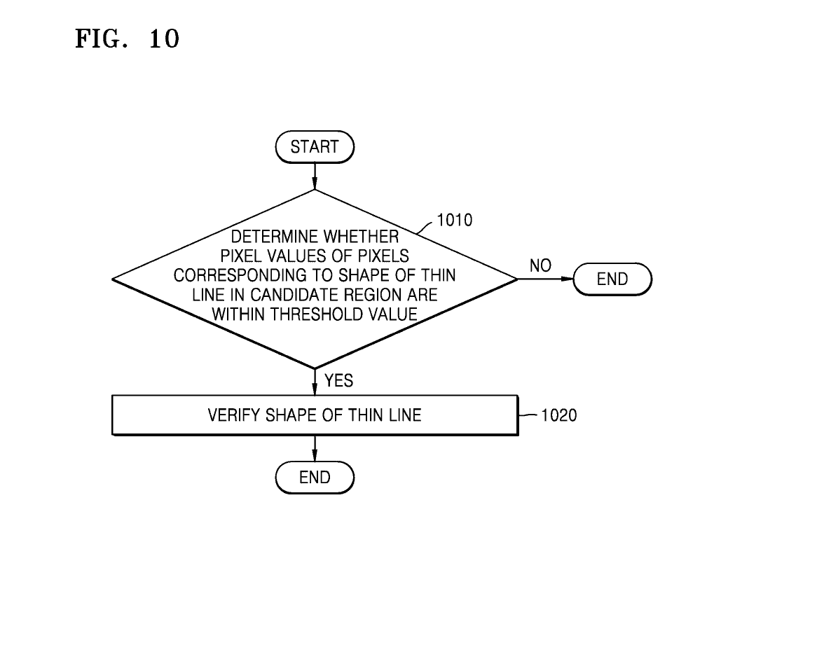

FIG. 10 is a flowchart of a method of determining, by the image forming apparatus 100, whether a thin line included in a candidate region is continuous, according to an embodiment.

Referring to FIG. 10, in operation 1010, the image forming apparatus 100 determines whether pixel values of pixels corresponding to a shape of a thin line in a candidate region are within a threshold range. Here, the threshold range may be determined by a pixel value of a center pixel. For example, the threshold range may be from (pixel value of center pixel−0x20) to (pixel value of center pixel+0x20). Alternatively, the threshold range may be an absolute range determined based on whether the thin line is a positive thin line or a negative thin line.

In detail, the image forming apparatus 100 may determine whether all pixel values of pixels corresponding to the shape of the thin line in the candidate region are within the threshold value. Alternatively, the image forming apparatus 100 may determine whether pixel values of pixels between a detail region classified as a thin line candidate region (or a thin line region) in the candidate region and the center pixel are within the threshold range. When the pixel values are within the threshold range, the image forming apparatus 100 may determine that the thin line is continuous.

When it is determined that the thin line is continuous, the image forming apparatus 100 performs operation 1020. When it is determined that the thin line is not continuous, the image forming apparatus 100 determines that the thin line is not included in the candidate region, and may perform an operation for selecting another candidate region. Accordingly, in operation 1010, the image forming apparatus 100 may distinguish the thin line included in the candidate region from a halftone pattern.

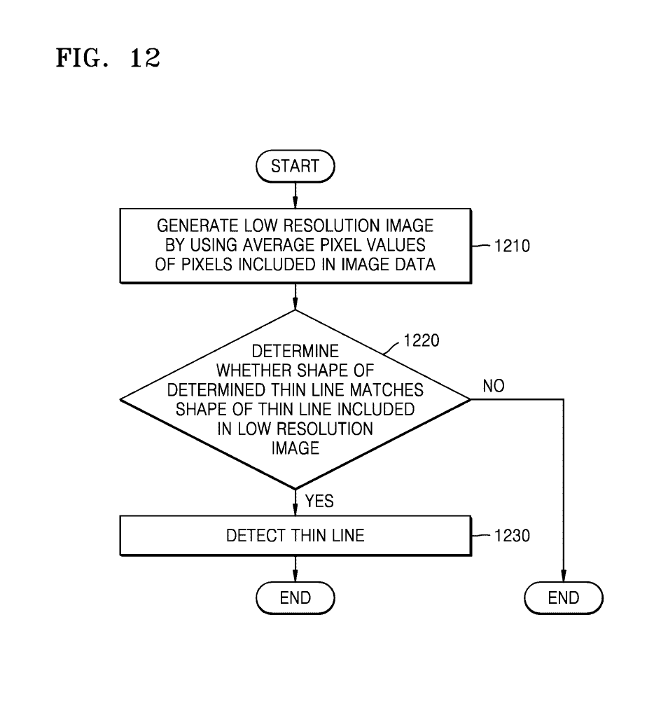

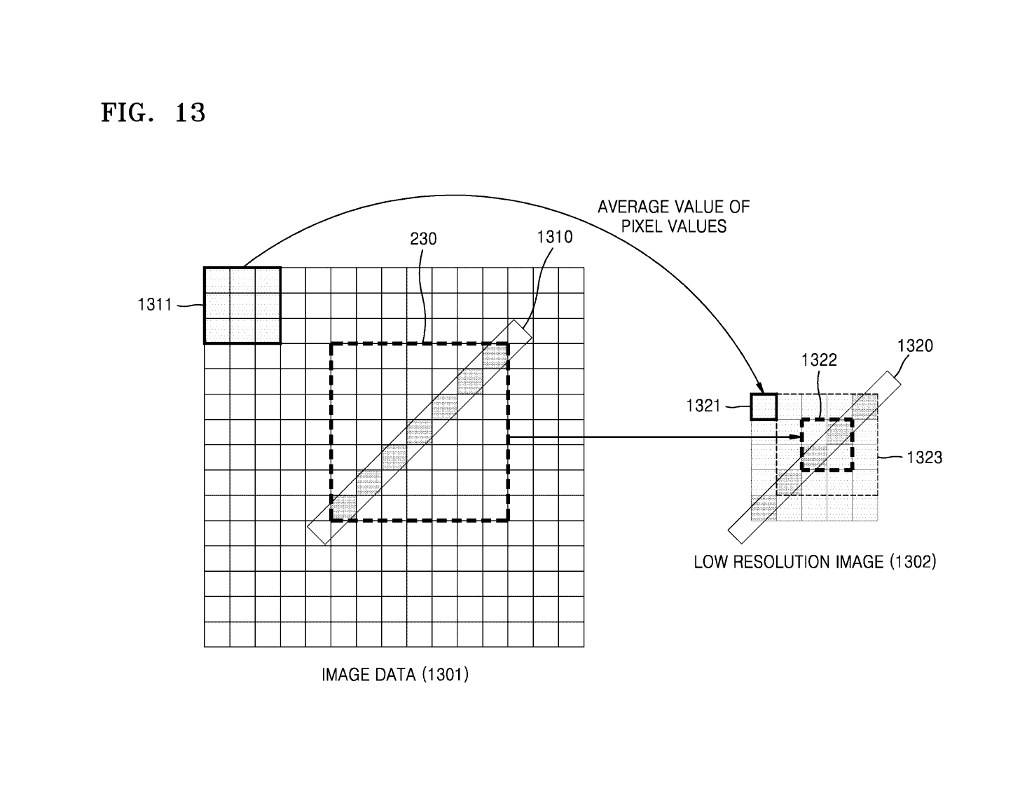

In operation 1020, the image forming apparatus 100 verifies a shape of the thin line. A method of verifying, by the image forming apparatus 100 the shape of the thin line will be described later with reference to FIGS. 12 and 13.

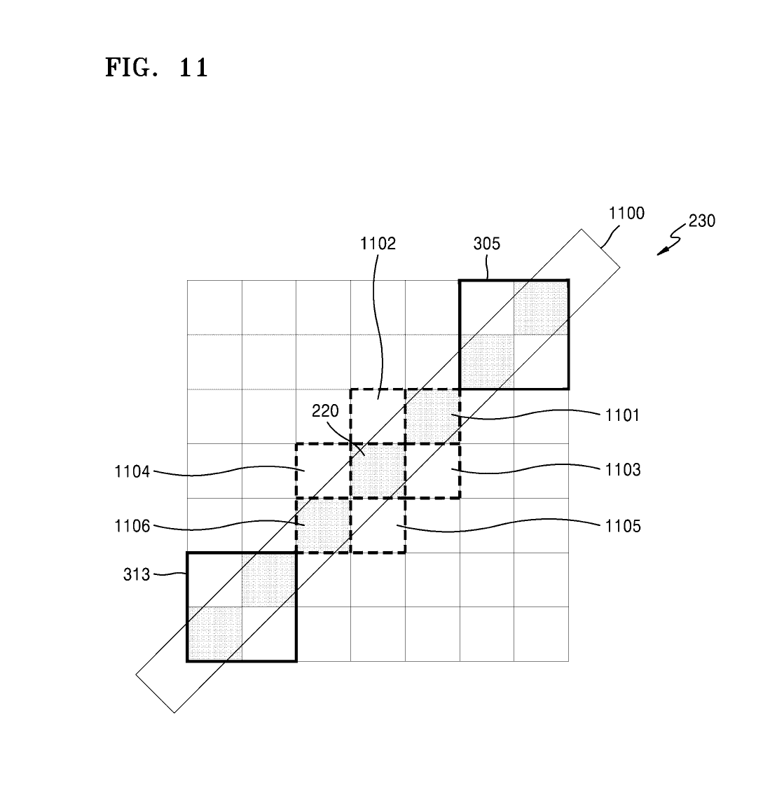

FIG. 11 illustrates an example of determining, by the image forming apparatus 100, whether a thin line included in a candidate region is continuous.

Referring to FIG. 11, the image forming apparatus 100 may determine whether pixel values of first through sixth pixels 1101 through 1106 located between the second pixel 220, i.e., a center pixel, and the third and thirteenth detail regions 305 and 313 classified as thin line candidate regions (or thin line regions) from among the first through sixteenth detail regions 301 through 316 of FIG. 3, are within a threshold value.

If the pixel values of the first through sixth pixels 1101 through 1106 are all within the threshold range, the image forming apparatus 100 determines that a thin line 1100 is continuous. However, when at least one of the pixel values of the first through sixth pixels 1101 through 1106 is outside the threshold range, the image forming apparatus 100 may determine that the thin line 1100 is not continuous.

FIG. 12 is a flowchart of a method of verifying, by the image forming apparatus 100, a shape of a thin line, according to an embodiment.

Referring to FIG. 12, in operation 1210, the image forming apparatus 100 generates a low resolution image by using average pixel values of pixels included in image data. For example, the image forming apparatus 100 may generate the low resolution image having a N:1 ratio with respect to a resolution of the image data. For example, an average pixel value of an N×N pixel region of the image data may correspond to a pixel value of a 1×1 pixel region of the low resolution image.

In operation 1220, the image forming apparatus 100 determines whether a shape of a thin line in a candidate region of the image data corresponds to a shape of a thin line included in the low resolution image. Here, it may be determined that the shapes match each other not only when the shapes are the same, but also when the shapes are within a predetermined error range (for example, an error range of −10% to +10% with respect to a gradient of the thin lines).

In detail, the image forming apparatus 100 may determine a verification region including a predetermined region corresponding to the candidate region from the low resolution image, and determine whether a thin line exists in the verification region. When the thin line exists in the verification region, the image forming apparatus 100 may determine whether a shape of the thin line in the verification region matches the shape of the thin line in the candidate region.

When the shapes match, the image forming apparatus 100 performs operation 1230. However, when the shapes do not match, the image forming apparatus 100 determines that the thin line does not exist in the candidate region and performs an operation for selecting another candidate region.

In operation 1230, the image forming apparatus 100 detects the thin line from the candidate region. For example, the image forming apparatus 100 may tag pixels detected as the thin line as a thin line object.

Also, the image forming apparatus 100 may perform an operation for adjusting pixel values of the pixels tagged as the thin line object. Also, the image forming apparatus 100 may not perform a descreening operation on the pixels tagged as the thin line object.

FIG. 13 illustrates an example of verifying, by the image forming apparatus 100, a shape of a thin line by using a low resolution image 1302.

Referring to FIG. 13, the image forming apparatus 100 may generate the low resolution image 1302 having a 9:1 ratio from image data 1301. In detail, a 3×3 pixel region 1311 of the image data 1301 may correspond to a 1×1 pixel region 1321 of the low resolution image 1302.

The image forming apparatus 100 may determine whether a shape 1310 of a thin line in the candidate region 230 and a shape 1320 of a thin line in the low resolution image 1302 match each other. In detail, the image forming apparatus 100 may determine a verification region 1323 including a predetermined region 1322 of the low resolution image 1302 corresponding to the candidate region 230 of the image data 1301, and determine whether a thin line exists in the verification region 1323. For example, the image forming apparatus 100 may compare pixel values of pixels in the verification region 1323 and the first threshold value to determine whether the thin line exists in the verification region 1323. When the thin line exists, the image forming apparatus 100 may determine whether the shape 1310 of the thin line in the candidate region 230 matches a shape of the thin line in the verification region 1323.

As such, the image forming apparatus 100 verifies a shape of a thin line by using the low resolution image 1302 so as not to make a mistake of detecting a halftone pattern as a thin line.

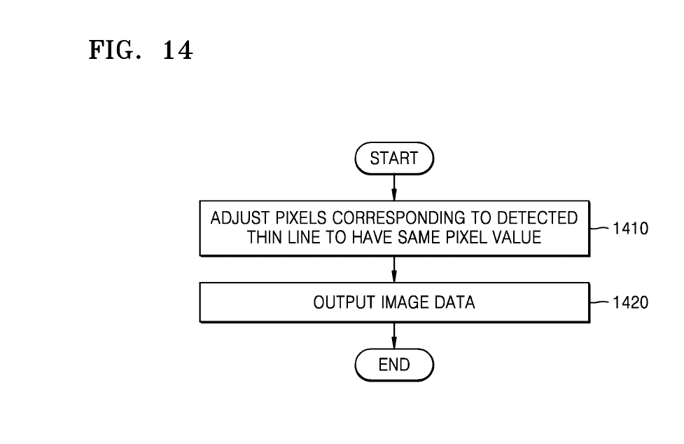

FIG. 14 is a flowchart of a method of adjusting and outputting, by the image forming apparatus 100, pixel values of a detected thin line, according to an embodiment.

Referring to FIG. 14, in operation 1410, the image forming apparatus 100 adjusts pixels corresponding to a detected thin line to have the same pixel value.

In detail, the image forming apparatus 100 may tag the pixels corresponding to the detected thin line as a thin line object. Also, when pixel values of the pixels tagged as the thin line object are within a black threshold value (for example, 0x000000 to 0x303030) or a white threshold range (for example, 0xCFCFCF to 0xFFFFFF), the image forming apparatus 100 may tag the pixels as a black object or a white object. The image forming apparatus 100 may adjust the pixel values of the pixels tagged as a black object to ‘0x000000’ and the pixel values of the pixels tagged as a white object to ‘0xFFFFFF’.

Alternatively, the image forming apparatus 100 may determine a combination pixel value (for example, 0x404040) by combining RGB minimum pixel values (for example, 0x40) or RGB maximum pixel values of the pixels tagged as the thin line object in a N×N pixel region. Here, whether to combine the RGB minimum pixel values or the RGB maximum pixel values may be determined based on whether the thin line is a positive thin line or a negative thin line. Also, the image forming apparatus 100 may adjust the pixels tagged as the thin line object to have the combination pixel value (for example, 0x404040). Also, according to an embodiment, the image forming apparatus 100 may multiply a uniform value (for example, 0.6 or 1.6) to the combination pixel value such that the thin line is clearly output.

If the image forming apparatus 100 uses a CMYK color space, the image forming apparatus 100 may adjust K pixel values of pixels tagged as a thin line object such that the pixels tagged as the thin line object have the same pixel values.

In operation 1420, the image forming apparatus 100 outputs (or prints) image data. In detail, the image forming apparatus 100 may determine a method of outputting the pixels tagged as the thin line object. For example, the image forming apparatus 100 may determine to output the pixels tagged as the thin line object in an error diffusion method. Here, the error diffusion method may be a method of diffusing an error generated by binarizing pixels to surrounding pixels such that the diffused error is reflected while binarizing the surrounding pixels.

Also, the image forming apparatus 100 may determine output concentration according to pixels via an updated value suppression method. Here, the updated value suppression method may be a method of reflecting a weight to a sum of a pixel value of a current pixel and an error diffused from another pixel through the error diffusion method. For example, the image forming apparatus 100 may determine output concentration of a pixel by using Equation 1 below according to the updated value suppression method.

Ui=(Vi+Ei−1)×w 1

In Equation 1, Vi denotes a pixel value of a current pixel and Ei−1 denotes an error diffused from surrounding pixels. Also, w denotes a weight. Accordingly, Ui may denote a pixel value revised by considering an error diffused from surrounding pixels. Here, when a thin line is a positive thin line, w may be smaller than 1, and when a thin line is a negative thin line, w may be larger than 1.

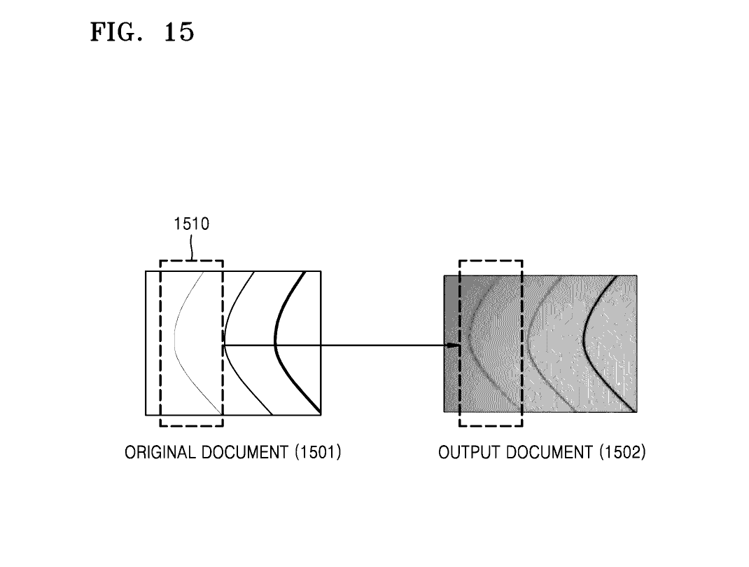

FIG. 15 illustrates an example of image data output by the image forming apparatus 100. Referring to FIG. 15, a left image is an original document 1501 scanned by the image forming apparatus 100, and a right image is an output document 1502 output by the image forming apparatus 100. As shown in FIG. 15, it is experimentally checked that the image forming apparatus 100 according to an embodiment outputs the output document 1502 including a thin line 1510 included in the original document 1501.

As such, the image forming apparatus 100 according to an embodiment may prevent a thin line of an original document from disappearing or being blurred while the original document is scanned and output.

FIGS. 16 through 18 are diagrams for describing the image forming apparatus 100 according to an embodiment. Hereinafter, the image forming apparatus 100 of FIGS. 16 through 18 is described with reference to FIGS. 1 through 15. Details and technical aspects described above may also be applied to the image forming apparatus 100 of FIGS. 16 through 18. Thus, details that overlap while describing FIGS. 16 through 18 may not be provided again.

FIG. 16 is a block diagram of an image forming apparatus 100 according to the embodiment. The image forming apparatus 100 is an apparatus that generates, outputs (or prints), receives, and transmits image data, and for example, may be an MFP in which functions of a printer, a scanner, a photocopier, and a facsimile are combined.

Referring to FIG. 16, the image forming apparatus 100 includes a controller 1610 and an output unit 1620. However, not all components shown in FIG. 16 are essential, and the image forming apparatus 100 may include more or less components than those shown in FIG. 16.

The controller 1610 controls operations of the image forming apparatus 100 in general. The controller 1610 performs an operation of detecting a thin line included in image data and an operation of adjusting pixel values of pixels corresponding to the thin line. Also, the controller 1610 provides the image data including the thin line to the output unit 1620.

Here, the thin line may be a group of pixels having the same or similar pixel values and may have a thickness of one or two pixels. The thin line may be classified into a positive thin line having saturation lower than adjacent pixels and a negative thin line having saturation higher than adjacent pixels.

The controller 1610 selects a candidate region that may include a thin line from the image data. In detail, the controller 1610 may compare pixel values included in the image data and a threshold value and select an N×N pixel region that is determined that a thin line may be included as the candidate region. Because an operation of selecting, by the controller 1610, the candidate region has been described above with reference to FIGS. 1 and 2, details thereof are not provided here.

The controller 1610 splits the candidate region into a plurality of detail regions. For example, the controller 1610 may split the candidate region into at least two detail regions including a plurality of pixels. However, the controller 1610 may not split all candidate regions into detail regions, but may split some of candidate regions into detail regions. For example, as shown in FIG. 3, the controller 1610 may split a candidate region into the first through sixteenth detail regions 301 through 316.

The controller 1610 determines a shape of the thin line by comparing pixel values of the detail regions. In detail, the controller 1610 may compare the pixel values of the detail regions to determine whether the thin line in the candidate region matches one of thin line candidate shapes that are pre-set. Here, the thin line candidate shape may include background regions and thin line regions. The controller 1610 may classify the detail regions into background candidate regions and thin line candidate regions to correspond to background regions and thin line regions of a first thin line candidate shape from among the thin line candidate shapes. The controller 1610 may compare pixel values of pixels of the detail region classified as the background candidate regions and pixel values of pixels corresponding to the thin line candidate regions to determine whether the thin line in the candidate region matches the first thin line candidate shape. Here, the controller 1610 may compare maximum or minimum pixel values corresponding to the background candidate regions and minimum or maximum pixel values corresponding to the thin line candidate regions based on whether the thin line in the candidate region is a positive thin line or a negative thin line.

For example, when the thin line is a positive thin line, the controller 1610 selects minimum pixel values of the detail regions, and determine that the thin line matches the first thin line candidate shape when minimum pixel values of the detail regions classified as the thin line candidate regions are smaller than minimum pixel values of the detail regions classified as the background candidate regions.

Alternatively, when the thin line is a negative thin line, the controller 1610 selects maximum pixel values of the detail regions, and determine that the thin line matches the first thin line candidate shape when maximum pixel values of the detail region classified as the thin line candidate region are larger than maximum pixel values of the detail region classified as the background candidate regions.

When the thin line and the first thin line candidate shape do not match, the controller 1610 may repeat the above-described operation to determine whether the thin line matches another thin line candidate shape.

Alternatively, the controller 1610 may classify the detail regions into the background regions and the thin line regions by comparing representative pixel values (maximum or minimum pixel values) of the detail regions and a threshold value. The controller 1610 may determine a shape of the thin line by connecting the thin line regions and a center pixel at the center of the candidate region. Because an operation of determining, by the controller 1610, a shape of a thin line has been described above with reference to FIGS. 4 through 9, details thereof are not provided here.

Also, the controller 1610 may check whether pixel values of pixels corresponding to a shape of a determined thin line are within a threshold range to determine whether the thin line is continuous. Because an operation of checking, by the controller 1610, whether a thin line is continuous is described above with reference to FIGS. 10 and 11, details thereof are not provided here.

The controller 1610 verifies a shape of a thin line. In detail, the controller 1610 may generate a low resolution image by using average pixel values of pixels included in image data. For example, the controller 1610 may generate the low resolution image having a 9:1 ratio of resolution of the image data. The controller 1610 may determine whether a shape of a thin line in a candidate region of the image data matches a shape of a thin line in the low resolution image. Here, it may be determined that the shapes match each other not only when the shapes are the same, but also when the shapes are within a predetermined error range (for example, an error range of −10% to +10% with respect to a gradient of the thin lines).

When the shapes match each other, the controller 1610 detects a thin line having the verified shape from the image data.

Also, the controller 610 may adjust pixels of a detected thin line to have the same pixel values.

The output unit 1620 outputs or prints image data including a detected thin line, the image data received from the controller 1610. Output resolution supported by the output unit 1620 is pre-set, and accordingly, the controller 1610 may adjust resolution of the image data.

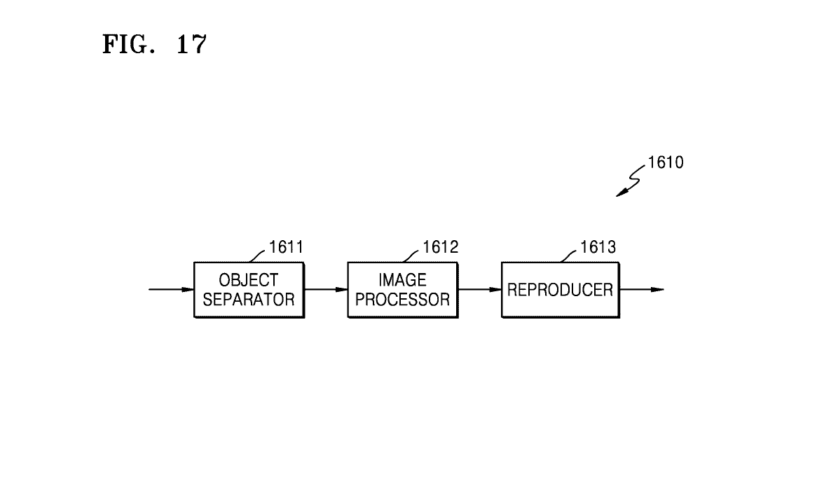

FIG. 17 is a block diagram of the controller 1610 of FIG. 16. Referring to FIG. 17, the controller 1610 includes an object separator 1611, an image processor 1612, and a reproducer 1613.

The object separator 1611 detects a thin line included in image data. Because an operation of detecting, by the object separator 1611, a thin line has been described above with reference to FIG. 16, details thereof are not provided here.

The object separator 1611 tags the detected thin line as a thin line object. Also, the object separator 1611 may tag background candidate regions (or background regions) included in a candidate region as a background object.

Also, the object separator 1611 may tag pixels corresponding to the detected thin line as a black object or a white object when pixel values of the pixels tagged as the thin line object are within a black threshold range (for example, 0x000000 to 0x303030) or a white threshold range (for example, 0xCFCFCF to 0xFFFFFF).

Also, the object separator 1611 may tag the pixels as a positive object or a negative object based on whether the detected thin line is a positive thin line or a negative thin line.

The object separator 1611 may adjust the pixels tagged as the thin line object to have the same pixel values. For example, the object separator 1611 may adjust the pixel values of the pixels tagged as the black object to ‘0x000000’ and the pixel values of the pixels tagged as the white object to ‘0xFFFFFF’.

Also, the object separator 1611 may combine RGB minimum pixel values of an N×N pixel region including the pixels tagged as the thin line object to adjust the pixel values of the pixels tagged as the thin line object to the combined RGB minimum pixel value. Also, the object separator 1611 may set a value obtained by multiplying a predetermined value to the combined RGB minimum pixel value as the pixel values of the pixels tagged as the thin line object.

The object separator 1611 may provide the pixels having the adjusted pixel values to the image processor 1612.

The image processor 1612 performs a descreening operation and a sharpening operation on pixels provided from the object separator 1611. Here, the descreening operation may be an operation of removing a halftone pattern in image data in order to prevent a Moiré phenomenon. Also, the sharpening operation may be a border enhancing operation for clarifying borders of objects in the image data.

Generally, a thin line may be deleted during a descreening operation as the thin line may be mistaken as a halftone pattern. The image processor 1612 may not perform the descreening operation on pixels tagged as a thin line object. Thus, the image processor 1612 may prevent the thin line from being deleted during the descreening operation.

The reproducer 1613 determines a method of outputting image data including a detected thin line. Also, the reproducer 1613 may generate and/or transmit control data for controlling operations of the output unit 1620.

The reproducer 1613 may determine image data to be output via an error diffusion method. Here, the error diffusion method may be a method of diffusing an error generated by binarizing pixels to surrounding pixels such that the diffused error is reflected while binarizing the surrounding pixels.

Also, reproducer 1613 may determine output concentration according to pixels via an updated value suppression method. Here, the updated value suppression method may be a method of reflecting a weight to a sum of a pixel value of a current pixel and an error diffused from another pixel through the error diffusion method.

According to an embodiment, functions of the reproducer 1613 may be performed by the output unit 1620.

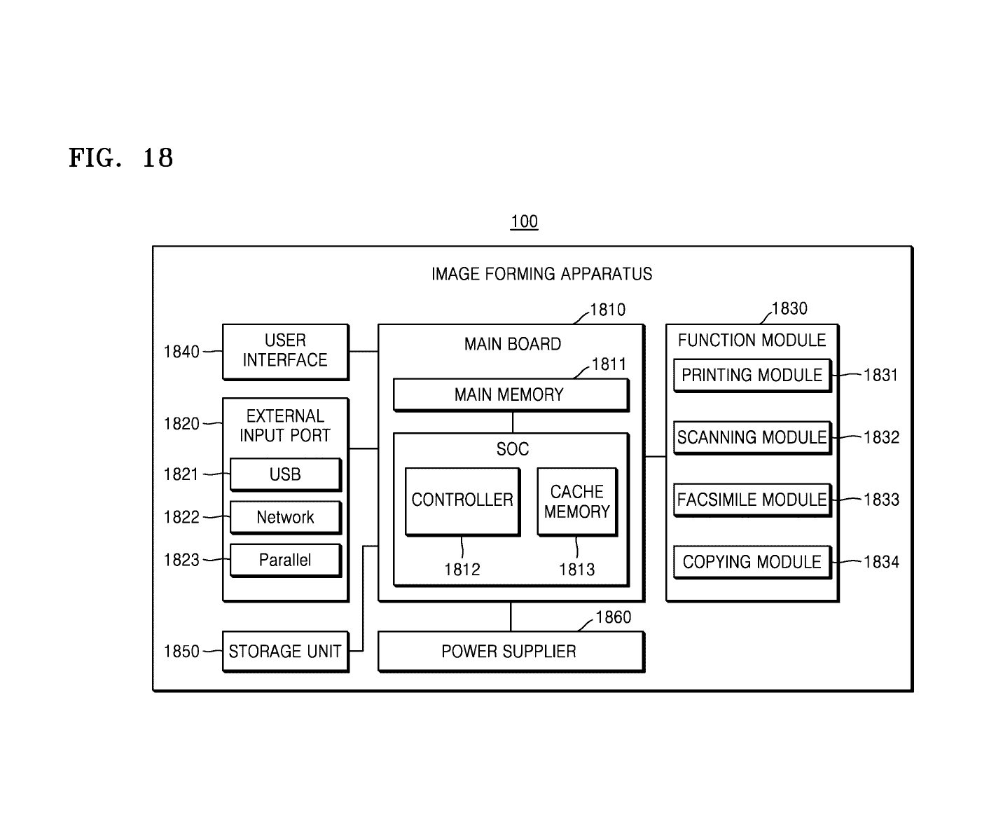

FIG. 18 is a block diagram illustrating in detail the image forming apparatus 100. Referring to FIG. 18, the image forming apparatus 100 includes a main board 1810, an external input port 1820, function module 1830, a user interface 1840, a storage unit 1850, and a power supplier 1860.

The main board 1810 provides a circuit that mutually connects components of the image forming apparatus 100. A main memory 1811, a controller 1812, and a cache memory 1813 may be mounted on the main board 1810.

The main memory 1811 is a large capacity memory, and a main kernel may reside in the main memory 1811. The main memory 1811 may be realized as a dynamic random access memory (DRAM).

The cache memory 1813 stores some pieces of data of the main memory 1811 for an efficient access of the controller 1812. The cache memory 1813 may be realized as a static random access memory (SRAM) having a fast read/write speed compared to the main memory 1811.

The controller 1812 controls overall operations of the image forming apparatus 100. The controller 1812 executes the main kernel residing in the main memory 1811 to control operations of the image forming apparatus 100.

Also, the controller 1812 may receive image data from the external input port 1820 or the storage unit 1850. The controller 1812 may control the function module 1830 such that a thin line in the image data is detected and the image data including the detected thin line is output. Because the controller 1812 corresponds to the controller 1610 of FIGS. 16 and 17, details thereof are not provided again.

The external input port 1820 exchanges data with an external input device (not shown). Examples of the external input device include a host computer, a mobile terminal, a digital camera, and a mobile disk. Examples of data received through the external input port 1820 may include print job data, user authentication information, authentication information of an external input device, commands related to maintenance of the image forming apparatus 100, and a default setting value of the image forming apparatus 100.

The print job data may be data in which an operation of the image forming apparatus 100, such as copying, sending a fax, scanning, or printing, is described in a print job language (PJL). Accordingly, the print job data is not limited to data for printing an image on a paper. When a function of user authentication or external input device authentication is set in the image forming apparatus 100, the image forming apparatus 100 may receive identification (ID) and a password for the user authentication or a device identifier for the external input device authentication through the external input port 1820. Information for the user authentication and the external input device authentication may be included in the print job data in the PJL.

The external input port 1820 may include at least one of, for example, a universal serial bus (USB) port 1821, a network interface port 1822, and a parallel port 1823. When the external input port 1820 includes the network interface port 1822, the network interface port 1822 may use a transmission control protocol (TCP) to transmit data through a network. The image forming apparatus 100 accesses the network through the network interface port 1822, and an internet protocol (IP) address is assigned to the image forming apparatus 100. Here, the image forming apparatus 100 may perform functions of a network printer and an Internet facsimile, may transmit an email and browse a web based on the IP address. For example, the image forming apparatus 100 may receive external image data through the external input port 1820.

Meanwhile, the USB port 1821 and the network interface port 1822 of the external input port 1820 may not only support wired connection, but also support wireless connection. For example, the external input port 1820 may include a wireless USB (WUSB) port or a wireless local area network (LAN) interface port.

The function modules 1830 performs a print function, a scanner function, a facsimile function, and a photocopier function included in the image forming apparatus 100. Meanwhile, the output unit 1620 of FIG. 16 may correspond to the function module 1830.

The function module 1830 may include a printing module 1831, a scanning module 1832, a facsimile module 1833, and a copying module 1834. In FIG. 18, it is assumed that the image forming apparatus 100 is an MFP, but when the image forming apparatus 100 performs only one function, some of modules included in the function module 1830 may be omitted. For example, when the image forming apparatus 100 only performs a printing function, the scanning module 1832, the facsimile module 1833, and the copying module 1834 may be omitted.

The user interface 1840 receives manipulation from a user, and displays a manipulation result to the user. The user interface 1840 may include a user input key for receiving the manipulation from the user. The user input key may be a physical button or may be realized on a touch screen. Also, the user interface 1840 may include a display unit (not shown) for displaying the manipulation result to the user. The display unit may be realized as a touch screen including functions of the user input key.

The storage unit 1850 stores image data received or generated by the image forming apparatus 100. When the image forming apparatus 100 includes a document boxing function of storing files according to users, the storage unit 1850 may provide storage for storing files to the users. For example, an image data file scanned and generated by the image forming apparatus 100, an original document file to be printed, an image data file exchanged via a facsimile, and print job data received through the external input port 1820 may be stored in the storage unit 1850.

The storage unit 1850 may store user authentication information for user authentication. In other words, the storage unit 1850 may store ID and a password for user authentication. In addition to the user authentication information, driver authentication information for authenticating a printer driver that requested a print according to an authentication method of the image forming apparatus 100, application authentication information for authenticating an application that requested a print, and device authentication information for authenticating a device that requested a print may be stored in the storage unit 1850.

The power supplier 1860 supplies power to the image forming apparatus 100 according to control of the controller 1812.

Meanwhile, names of the components of the image forming apparatus 100 described above with reference to FIGS. 16 through 18 may differ according to embodiments.

The embodiments may be written as computer programs and may be implemented in general-use digital computers that execute the programs using a non-transitory computer-readable recording medium.

Also, when a communication with a remote computer or server is required by a processor of a computer to execute the above-described functions, the processor of the computer may further include information about how the communication is performed with the remote computer or server by using a communication module (for example, a wired and/or wireless communication module) of the computer, and about information or media to be exchanged during the communication.

Also, functional programs, codes, and code segments for accomplishing the present disclosure may be easily construed by programmers skilled in the art to which the present disclosure pertains, considering system environments of a computer executing a program by reading the non-transitory recording medium.

Examples of the non-transitory computer-readable recording medium include magnetic storage media (e.g., ROM, floppy disks, hard disks, etc.), optical recording media (e.g., CD-ROMs, or DVDs), etc.

Also, the non-transitory computer-readable recording medium may also be distributed over network coupled computer systems so that the computer-readable code is stored and executed in a distributed fashion. Here, at least one of a plurality of distributed computers may perform some of the above-described functions and transmit execution results to the remaining at least one of the plurality of distributed computers, and the remaining at least one of the plurality of distributed computers may perform some of the above-described functions to provide execution results to the at least one of the plurality of distributed computers.

Hereinabove, all components according to the embodiments are described to be combined as one or are described to operate by being combined with each other, but an embodiment is not limited thereto. In other words, at least two of the components may selectively combine to operate within the scopes of the present disclosure. Also, the components may each be realized as independent hardware, or some or all of the components may be selectively combined to be realized as a computer program having a program module in which some or all functions are performed in one or more pieces of hardware.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of detecting, by an image forming apparatus, a thin line, the method comprising:
selecting, by a controller of the image forming apparatus, a candidate region from image data;
splitting the candidate region into a plurality of detail regions;
determining a shape of a candidate thin line in the candidate region by comparing pixel values of the plurality of detail regions; and
detecting the thin line based on the determined shape of the candidate thin line.

2. The method of claim 1, wherein the determining of the shape of the candidate thin line comprises classifying the plurality of detail regions into background candidate regions and thin line candidate regions to correspond to a thin line candidate shape comprising background regions and thin line regions.

3. The method of claim 2, wherein the determining of the shape of the candidate thin line further comprises:
determining whether the candidate thin line included in the candidate region matches the thin line candidate shape by comparing pixel values of pixels corresponding to the background candidate regions and pixel values of pixels corresponding to the thin line candidate regions; and
when the candidate thin line matches the thin line candidate shape, determining the thin line candidate shape as the shape of the candidate thin line.

4. The method of claim 3, wherein the determining of whether the candidate thin line matches the thin line candidate shape comprises selecting minimum pixel values of the plurality of detail regions and determining whether minimum pixel values of detail regions classified as thin line candidate regions are smaller than minimum pixel values of detail regions classified as the background candidate regions, and
the determining of the shape of the candidate thin line comprises, when the candidate thin line matches the thin line candidate shape, determining the candidate thin line as a positive thin line having the thin line candidate shape.

5. The method of claim 3, wherein the determining of whether the candidate thin line matches the thin line candidate shape comprises selecting maximum pixel values of the plurality of detail regions and determining whether maximum pixel values of detail regions classified as the thin line candidate regions are larger than maximum pixel values of detail regions classified as the background candidate regions, and
the determining of the shape of the candidate thin line comprises, when the candidate thin line matches the thin line candidate shape, determining the candidate thin line as a negative thin line having the thin line candidate shape.

6. The method of claim 3, wherein the determining of the shape of the candidate thin line further comprises checking the shape of the candidate thin line by determining whether pixel values of pixels corresponding to the shape of the candidate thin line are within a threshold range.

7. The method of claim 1, wherein the detecting of the thin line comprises detecting the thin line when a shape of a thin line included in a low resolution image of the image data matches the shape of the thin line.

8. The method of claim 7, wherein the low resolution image is an image generated by using an average pixel value of pixels of the image data.

9. The method of claim 1, wherein the detecting of the thin line comprises adjusting pixels corresponding to the thin line to have a same pixel value.

10. The method of claim 1, wherein the candidate region comprises a pixel having a pixel value that is different from pixel values of adjacent pixels by at least a threshold value, from among the pixels included in the image data.

11. An image forming apparatus comprising:
a controller configured to select a candidate region from image data, split the candidate region into a plurality of detail regions, determine a shape of a candidate thin line by comparing pixel values of the plurality of detail regions, and detect the thin line based on the determined shape of the candidate thin line; and
an output unit configured to output the image data comprising the detected thin line.

12. The image forming apparatus of claim 11, wherein the controller classifies the plurality of detail regions into background candidate regions and thin line candidate regions to correspond to a thin line candidate shape comprising background regions and thin line regions.

13. The image forming apparatus of claim 12, wherein the controller determines whether the candidate thin line included in the candidate region matches the thin line candidate shape by comparing pixel values of pixels corresponding to the background candidate regions and pixel values of pixels corresponding to the thin line candidate regions, and when the candidate thin line matches the thin line candidate shape, determines the thin line candidate shape as the shape of the candidate thin line.

14. The image forming apparatus of claim 13, wherein the controller selects minimum pixel values of the plurality of detail regions, determines that the candidate thin line matches the thin line candidate shape when minimum pixel values of detail regions classified as thin line candidate regions are smaller than minimum pixel values of detail regions classified as the background candidate regions, and determines the candidate thin line as a positive thin line having the thin line candidate shape.

15. The image forming apparatus of claim 13, wherein the controller selects maximum pixel values of the plurality of detail regions, determines that the candidate thin line matches the thin line candidate shape when maximum pixel values of detail regions classified as the thin line candidate regions are larger than maximum pixel values of detail regions classified as the background candidate regions, and determines the candidate thin line as a negative thin line having the thin line candidate shape.

16. The image forming apparatus of claim 13, wherein the controller checks the shape of the candidate thin line by determining whether pixel values of pixels corresponding to the shape of the candidate thin line are within a threshold range.

17. The image forming apparatus of claim 11, wherein the controller detects the thin line when a shape of a thin line included in a low resolution image of the image data matches the shape of the thin line.

18. The image forming apparatus of claim 17, wherein the low resolution image is an image generated by using an average pixel value of pixels of the image data.

19. The image forming apparatus of claim 11, wherein the controller adjusts pixels corresponding to the thin line to have a same pixel value.

20. A non-transitory computer-readable recording medium having recorded thereon a program, which when executed by a computer, performs the method of claim 1.
